(19) United States
(12) Patent Application Publication
(10) Pub. No.: US 2016/0313169 A1
(43) Pub. Date: Oct. 27, 2016

(54) Apparatus for Measuring Fill Level of a Substance in a Container

(71) Applicant: ENDRESS+HAUSER GMBH+CO. KG, Maulburg (DE)

(72) Inventors: Stefan Gorenflo, Hausen (DE); Ralf Reimelt, Freiburg (DE)

(21) Appl. No.: 15/100,767

(22) PCT Filed: Nov. 3, 2014
(86) PCT No.: PCT/EP2014/073522

§ 371 Date: Jun. 1, 2016

(30) Foreign Application Priority Data
Dec. 10, 2013 (DE) 102013113766.0

(51) Int. Cl. G01F 23/284; G01F 23/296; G01F 23/292; G01F 23/26

(52) U.S. Cl. CPC G01F 23/2845; G01F 23/261; G01F 23/263; G01F 23/2962; G01F 23/2928

(57) ABSTRACT

Apparatus for measuring fill level of a fill substance in a container, comprising a fill-level sensor, which is so embodied that it determines fill level via a travel-time difference measuring method or a capacitive measuring method, a limit-level sensor for monitoring a limit-level of the fill substance in the container, and an electronics unit, which is associated with the fill-level sensor and/or the limit-level sensor. The electronics unit determines based on measurement data of the fill-level sensor the fill level of the fill substance in the container, and wherein the electronics unit monitors based on measurement data of the limit-level sensor (2) the limit-level of the fill substance in the container.

The invention relates to an apparatus for measuring the fill level of a fill substance in a container, with a fill-level sensor, a limit-level sensor and an electronics unit.

For determining the fill level of a fill substance in a container, measuring systems are applied, which measure various physical variables. Based on these variables, the desired information concerning the fill level is then derived. Besides mechanical detectors, capacitive, conductive and hydrostatic measuring probes are applied, as well as measuring devices, which work based on ultrasound, microwaves or radioactive radiation.

In the case of travel-time methods with electromagnetic high-frequency pulses (TDR methods or pulse radar methods) or with continuous, frequency modulated microwaves (e.g. FMCW radar methods), the measurement signals are in-coupled on a conductive element, respectively a waveguide, and introduced by means of the waveguide into the container, in which the fill substance is located. Used as waveguides are known variants: the surface waveguides of Sommerfeld, Goubau and Lecher.

Capacitive fill level measurement uses the change of capacitance of a capacitor formed, in part, by the liquid when the fill level changes. For the measuring, a probe located in the interior and the electrically conducting container wall form an electrical capacitor. Alternatively, also two separate probes can be immersed into the liquid of the container, in order to form an electrical capacitor.

When the probe is located in air, a certain low starting capacitance is measured. If the container is filled, then the capacitance of the capacitor rises with increasing covering of the probe. In the case of connecting the capacitive probe as a limit-level switch, such switches when the capacitance set in the calibration is reached.

In most applications in the case of continuous fill level measuring technology, supplemental limit-level sensors are installed in the container, in order to avoid overflow in the case of malfunction. By this added redundancy, a safety endangering risk can be strongly minimized. Disadvantageous is the additional complexity resulting from additional measuring devices, connections, wiring and electronics unit.

An object of the invention is to provide an apparatus, which determines fill level of a fill substance in a container and with little complexity and cost warns before an overflow of the container.

The object is achieved according to the invention by the subject matter of the invention. The subject matter of the invention is an apparatus for measuring fill level of a fill substance in a container. The apparatus includes a fill-level sensor, which is so embodied that it determines fill level via a travel-time difference measuring method or a capacitive measuring method, a limit-level sensor for monitoring a limit-level of the fill substance in the container, and an electronics unit, which is associated with the fill-level sensor and/or the limit-level sensor. The electronics unit determines based on measurement data of the fill-level sensor the fill level of the fill substance in the container and monitors based on measurement data of the limit-level sensor the limit-level of the fill substance in the container.

The object of the invention is achieved by integrating the limit-level sensor and the level sensor in one apparatus. Since the apparatus has both a fill-level sensor and a limit-level sensor, it is possible cost effectively and with little effort to determine the fill level of the fill substance in the container and to warn timely before an overflow of the fill substance from the container.

In an advantageous embodiment, the fill-level sensor is embodied as a TDR fill-level sensor for measuring the fill level based on time-domain reflectometry.

In an advantageous embodiment, the fill-level sensor is embodied as a metal rod or as a metal cable.

In an advantageous embodiment, the fill-level sensor is embodied as a coaxial probe for capacitively measuring fill level.

The capacitive probe forms a capacitor with the fill substance as dielectric, whose fill level changes the capacitance of the capacitor.

In an advantageous form of embodiment, the fill-level sensor is embodied as a radar antenna or as an ultrasonic sensor.

Radar antenna and ultrasonic sensor are components, which offer precision to the travel-time method.

In an advantageous variant, the limit-level sensor is embodied as a thermal, resistive, optical or capacitive limit-level sensor.

A thermal limit-level sensor changes its thermal conductivity as a function of covering by a fill substance. A resistive limit-level sensor changes its electrical conductivity as a function of covering by a fill substance. An optical limit-level sensor changes its light transmission as a function of covering by a fill substance. A capacitive limit-level sensor changes its capacitance as a function of covering by a fill substance.

In an advantageous variant, the limit-level sensor is embodied as a gas sensor for determining measured variables of surrounding air.

Optical or semiconductor based sensors can be used for measuring gas. An example of an embodiment is a metal oxide gas sensor (MOX), which measures gas concentration based on pn junction conductivity, which changes by adsorption of gas molecules. If this pn junction is immersed in a fill substance, such is recognized based on the conductivity. By means of a gas sensor, other process properties can be supplementally derived, which can be taken into consideration for a diagnosis.

The invention will now be explained in greater detail based on the appended drawing, the figures of which show as follows:

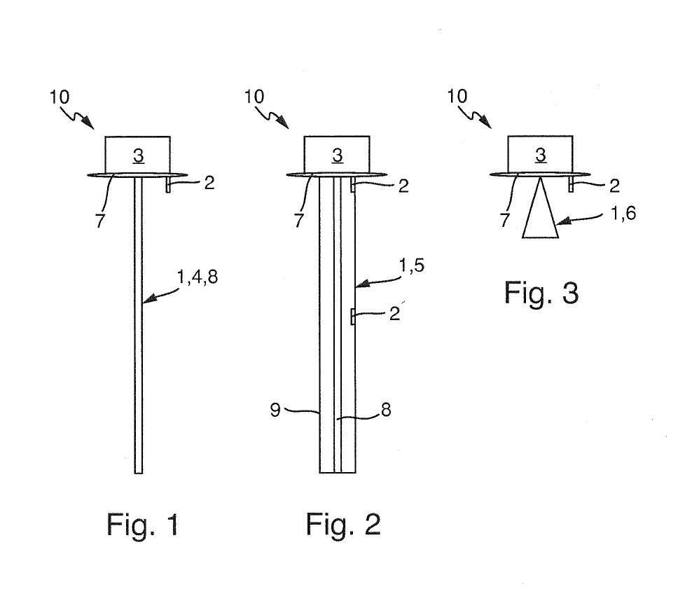

FIG. 1 a laterally viewed longitudinal section of an apparatus of the invention with a metal rod and a limit-level sensor,

FIG. 2 a laterally viewed longitudinal section of an apparatus of the invention with a coaxial probe and two limit-level sensors, and

FIG. 3 a laterally viewed longitudinal section of an apparatus of the invention with a radar antenna and a limit-level sensor.

FIG. 1 shows a laterally viewed longitudinal section of an apparatus 10 of the invention. Apparatus 10 includes an electronics unit 3, which is arranged on a first face of a plate 7. Plate 7 has a second face facing oppositely from its first face. Extending centrally from the second face of the plate 7 is a metal rod 8. Metal rod 8 is cylindrical. Also arranged on the second face of the plate 7 is a limit-level sensor 2. Limit-level sensor 2 is arranged laterally toward the edge of the second face of the plate 7.

Metal rod 8 can be used both as a TDR fill-level sensor for measuring the fill level per time-domain reflectometry, as well as also for capacitive fill level measurement. In the case of a capacitive fill level measurement, metal rod 8 forms a first electrode, a container, in which a fill substance is located, a second electrode and the fill substance between the metal rod 8 and the container a dielectric. The higher the fill level of the fill substance, the more dielectric is located between the metal tube 8 (first electrode) and the container (second electrode). If the metal rod 8 and the container, as electrodes of a capacitor, are supplied with an alternating voltage from the electronics unit 3, the fill level of the fill substance in the container can be ascertained based on the response signal to the alternating voltage.

In the case of operating the metal, rod 8 as a TDR fill-level sensor, the electronics unit 3 produces an electrical pulse and couples the electrical pulse onto the metal rod 8. A part of this electrical pulse is reflected on the surface of the fill substance and, in this way, returns via the metal rod 8 back to the electronics unit 3. Based on the travel time of the pulse, the electronics unit 3 can determine the fill level of the fill substance in the container.

If the fill level reaches the limit-level sensor 2, the limit-level sensor 2 is covered by the fill substance and the limit-level sensor 2 reports the state “covered” to the electronics unit 3.

FIG. 2 shows a laterally viewed longitudinal section of an additional embodiment of an apparatus 10 of the invention. Apparatus 10 includes an electronics unit 3, which is arranged on a first face of a plate 7. Arranged on a second face of the plate 7 is a fill-level sensor 1, wherein the fill-level sensor 1 is embodied as a coaxial probe 5. The coaxial probe 5 is embodied as a metal rod 8, which is arranged centrally in a metal tube 9. Metal rod 8 and metal tube 9 form two electrodes and the fill substance between the metal rod 8 and the metal tube 9 forms the dielectric of a capacitor, whose capacitance changes as a function of the fill level of the fill substance.

First and second limit-level sensors 2 are arranged on an outer surface of the metal tube 9. The first limit-level sensor 2 is arranged on an end of the metal tube 9 at the second face of the plate 7 and the second limit-level sensor 2 is arranged on the metal tube 9 halfway down the metal tube 9. The two limit-level sensors 2 can monitor the exceeding of the limit-level of the fill substance at two different fill levels. As soon as the fill level of the fill substance reaches one of the two limit-level probes 2, the particular limit-level probe 2 is covered with fill substance. This limit-level probe 2 reports the state “covered” to the electronics unit 3, whereby a further rising of the fill substance can be prevented. With the help of distributed limit-level sensors, continuous measurement results can be supplementally implemented.

FIG. 3 shows a laterally viewed longitudinal section of a third example of an embodiment of an apparatus 10 of the invention. Apparatus 10 includes an electronics unit 3 on a first face of a plate 7. The second face of the plate 7 includes a funnel-shaped radar antenna 6, which functions as a fill-level sensor 1. The radar antenna 6 sends radar waves, which are beamed by the funnel shape toward the fill substance. If the radar waves strike the surface of the fill substance, they are reflected and received by the radar antenna 6. Radar antenna 6 transduces the received electromagnetic waves into electrical signals and forwards these to the electronics unit 3. The electronics unit 3 determines from the travel time of the electromagnetic waves the fill level of the fill substance in the container.

A limit-level sensor 2 is arranged near the outer edge of the second face of the plate 7. As soon as the fill level of the fill substance reaches the limit-level probe 2, the fill substance covers it and the limit-level sensor 2 reports the state “covered” to the electronics unit. In this way, a further rising of the fill substance can be prevented.

### LIST OF REFERENCE CHARACTERS

1 fill-level sensor
2 limit-level sensor
3 electronics unit
4 TDR fill-level sensor
5 coaxial probe
6 radar antenna
7 plate
8 metal rod
9 metal tube
10 apparatus

1-7. (canceled)

8. An apparatus for measuring fill level of a fill substance in a container, comprising:
a fill level sensor, which is so embodied that it determines fill level via one of:
a travel-time difference measuring method and a capacitive measuring method;
a limit-level sensor for monitoring a limit-level of the fill substance in the container; and
an electronics unit, which is associated with said fill-level sensor and/or said limit-level sensor, wherein:
said electronics unit determines, based on measurement data of said fill-level sensor, the fill level of the fill substance in the container; and
said electronics unit monitors, based on measurement data of said limit-level sensor the limit-level of the fill substance in the container.

9. The fill-level measuring device as claimed in claim 8, wherein:
said fill-level sensor is embodied as a TDR fill-level sensor for measuring the fill level based on time-domain reflectometry.

10. The fill-level measuring device as claimed in claim 9, wherein:
said fill-level sensor is embodied as a metal rod or as a metal cable.

11. The fill-level measuring device as claimed in claim 8, wherein:
said fill-level sensor is embodied as a coaxial probe for capacitively measuring fill level.

12. The fill-level measuring device as claimed in claim 8, wherein:
said fill-level sensor is embodied as a radar antenna or as an ultrasonic sensor.

13. The fill-level measuring device as claimed in claim 8, wherein:
said limit-level sensor is embodied as a thermal, resistive, optical or capacitive limit-level sensor.

14. The fill-level measuring device as claimed in claim 8, wherein:
said limit-level sensor is embodied as a gas sensor for determining measured variables of surrounding air.
